(19) United States
(12) Patent Application Publication
(10) Pub. No.: US 2023/0162079 A1
(43) Pub. Date: May 25, 2023

(54) METHOD AND APPARATUS FOR OBTAINING GROUND STATE OF QUANTUM SYSTEM

(71) Applicant: Tencent Technology (Shenzhen) Company Limited, Shenzhen, Guangdong (CN)

(72) Inventors: Yuqin CHEN, Shenzhen (CN); Shixin ZHANG, Shenzhen (CN); Shengyu ZHANG, Shenzhen (CN)

(73) Assignee: Tencent Technology (Shenzhen) Company Limited, Shenzhen, Guangdong (CN)

(21) Appl. No.: 17/991,736

(22) Filed: Nov. 21, 2022

Related U.S. Application Data
(63) Continuation of application No. PCT/CN2021/126203, filed on Oct. 25, 2021.

(30) Foreign Application Priority Data
Jun. 29, 2021 (CN) 202110726300.8

(51) Int. Cl. G06N 10/20; G06N 10/60

(52) U.S. Cl. CPC G06N 10/20; G06N 10/60

(57) ABSTRACT

Some aspects of the disclosure provide a method for obtaining a ground state of a quantum system. The method includes preparing an initial state of the quantum system and performing an n-step evolution and post-processing operation on the quantum system, where n is a first positive integer. The n-step evolution and post-processing operations includes one or more steps that increase a proportion of the ground state in one or more output states of the one or more steps step by step. The method also includes obtaining an output quantum state in an n^{th} step in the n-step evolution and post-processing operation and determining the ground state of the quantum system based on the output quantum state in the n^{th} step in the n-step evolution and post-processing operation. Apparatus and non-transitory computer-readable storage medium counterpart embodiments are also contemplated.

### RELATED APPLICATIONS

The present application is a continuation of International Application No. PCT/CN2021/126203, entitled “METHOD AND APPARATUS FOR OBTAINING GROUND STATE OF QUANTUM SYSTEM, DEVICE, MEDIUM, AND PROGRAM PRODUCT” and filed on Oct. 25, 2021, which claims priority to Chinese Patent Application No. 202110726300.8, entitled “METHOD AND APPARATUS FOR OBTAINING GROUND STATE OF QUANTUM SYSTEM, DEVICE, MEDIUM, AND PROGRAM PRODUCT” filed on Jun. 29, 2021. The entire disclosures of the prior applications are hereby incorporated by reference in their entirety.

### FIELD OF THE TECHNOLOGY

Embodiments of this application relate to the field of quantum technologies, including determining a ground state of a quantum system.

### BACKGROUND OF THE DISCLOSURE

A ground state of a quantum system refers to an eigenstate of the quantum system with lowest energy. Obtaining a ground state of a quantum system represents obtaining a most stable state of the quantum system, which has important applications in many studies.

In the related art, a solution to solving the ground state of the quantum system based on imaginary time evolution is provided. A theory of solving the ground state in this solution is clear, which makes a process of approaching the ground state have theoretical guarantee. But e^{-Hτ} it uses is non-unitary, and cannot be directly decomposed into a single bit gate or a double bit gate which is applicable to a quantum circuit, which makes it difficult to implement this solution in an actual implementation.

### SUMMARY

Embodiments of this disclosure provide a method, an apparatus, a device, a medium, and a program product for obtaining a ground state of a quantum system.

Some aspects of the disclosure provide a method for obtaining a ground state of a quantum system. The method includes preparing an initial state of the quantum system and performing an n-step evolution and post-processing operation on the quantum system, where n is a first positive integer. The n-step evolution and post-processing operations includes one or more steps that increase a proportion of the ground state in one or more output states of the one or more steps step by step. The method also includes obtaining an output quantum state in an n^{th} step in the n-step evolution and post-processing operation and determining the ground state of the quantum system based on the output quantum state in the n^{th} step in the n-step evolution and post-processing operation.

Some aspects of the disclosure provide an apparatus for obtaining a ground state of a quantum system. The apparatus includes processing circuitry. The processing circuitry prepares an initial state of the quantum system, and performs an n-step evolution and post-processing operation on the quantum system, where n is a first positive integer. The n-step evolution and post-processing operations includes one or more steps that increase a proportion of the ground state in one or more output states of the one or more steps step by step. The processing circuitry obtains an output quantum state in an n^{th} step in the n-step evolution and post-processing operation, and determines the ground state of the quantum system based on the output quantum state in the n^{th} step in the n-step evolution and post-processing operation.

Some aspects of the disclosure provide another method for obtaining a ground state of a quantum system. The method includes using a variational quantum circuit to construct a trial quantum state, adjusting one or more parameters of the variational quantum circuit to cause the trial quantum state to approach a target quantum state of the quantum system, setting the trial quantum state constructed by using the variational quantum circuit as a ground state of the quantum system in response to the one or more parameters of the variational quantum circuit meeting a stop optimization condition, and determining an energy expectation value of a Hamiltonian of the quantum system under the trial quantum state as a ground state energy of the quantum system.

The technical solutions provided in the embodiments of this disclosure may include the following beneficial effects:

The target quantum system is gradually evolved from the initial state to the ground state by performing multi-step evolution and post-processing on the target quantum system, to obtain the ground state of the target quantum system. In the evolution process, the auxiliary qubit is introduced to implement unitary evolution, thereby providing a quantum simulation algorithm based on a non-Hermitian process, to simulate the ground state of the target quantum system. A real-time unitary evolution related to a Hamiltonian of the system is used for achieving an effect of virtual and real evolution, thus implementing simulation of the ground state of the target quantum system in theory. In addition, this process can be directly implemented by using a quantum circuit, which fully improves operability of the solution.

### BRIEF DESCRIPTION OF THE DRAWINGS

To describe technical solutions in embodiments of this disclosure more clearly, the following briefly introduces accompanying drawings required for describing the embodiments. The accompanying drawings in the following description show some embodiments of this disclosure.

FIG. 1 is a flowchart of a method for obtaining a ground state of a quantum system according to an embodiment of this disclosure.

FIG. 2 is a schematic diagram of a structure of a quantum circuit for implementing a non-Hermitian quantum simulation algorithm according to an embodiment of this disclosure.

FIG. 3 is a schematic diagram of a structure of a quantum circuit for implementing a non-Hermitian quantum simulation algorithm in combination with a variational quantum circuit according to an embodiment of this disclosure.

FIG. 4 is a schematic diagram of compressing a quantum state by using a variational quantum circuit according to an embodiment of this disclosure.

FIG. 5 is a schematic diagram of experimental data according to an embodiment of this disclosure.

FIG. 6 is a schematic diagram of experimental data according to another embodiment of this disclosure.

FIG. 7 is a schematic diagram of experimental data according to another embodiment of this disclosure.

FIG. 8 is a block diagram of an apparatus for obtaining a ground state of a quantum system according to an embodiment of this disclosure.

### DESCRIPTION OF EMBODIMENTS

To make objectives, technical solutions, and advantages of this disclosure clearer, the following further describes implementations of this disclosure in further detail with reference to the accompanying drawings.

The following are explanations of some key terms involved in this disclosure.

1. Quantum computing: It refers to a calculation method based on quantum logic, and a basic unit storing data is qubit.

2. Qubit: It refers to a basic unit of quantum computing. 0 and 1 are used as basic units of binary in the related computers. Unlike the related computers, 0 and 1 can be processed at the same time through quantum computing, and a system can be in a linear superposition state of 0 and 1: |ψ [symbol] α|0 [symbol] +β|1 [symbol] . α and β represent complex probability amplitudes of the system on 0 and 1. Squares of their moduli |α|² and |β|² respectively represent probabilities of being at 0 and 1.

3. Quantum circuit: It is a representation of a universal quantum computer, and represents hardware implementation of a corresponding quantum algorithm/program under a quantum gate model. If the quantum circuit includes an adjustable parameter to control a quantum gate, it is called a parameterized quantum circuit (PQC) or a variational quantum circuit (VQC), both of which are the same concept.

4. Hamiltonian: It refers to a Hermitian conjugate matrix describing total energy of a quantum system. The Hamiltonian is a physical term and an operator describing total energy of a system, which is usually represented by H.

5. Eigenstate: For a Hamiltonian matrix H, a solution meeting an equation H|ψ [symbol] =E|ψ [symbol] is called an eigenstate |ψ [symbol] of H, and has eigenenergy E. A ground state corresponds to an eigenstate of a quantum system with a lowest energy.

6. Noisy intermediate-scale quantum (NISQ): NISQ hardware in the near future is a key direction of the current stage and research of quantum computing development. At this stage, due to limitation of a scale and noise, the quantum computing cannot be used as an engine of general computing for the time being, but on some issues, it can already achieve a result of surpassing a strongest classic computer, which is often called quantum hegemony or quantum superiority.

7. Variational quantum eigensolver (VQE): Estimation for a ground state energy of a specific quantum system through a variational circuit (PQC/VQC) is a typical quantum classical hybrid computational paradigm, which is widely applied to the field of quantum chemistry.

8. Non-unitary: All unitary matrices meet U^{†}U=I, and all evolution processes directly allowed in quantum mechanics can be described by the unitary matrix. U is a unitary matrix. U^{†} is a conjugate transpose of U. In addition, a matrix that does not meet the condition is non-unitary, which can only be experimentally implemented through auxiliary means or even exponential resources. However, a non-unitary matrix often has a stronger expression capability and faster ground state projection effect. The foregoing “exponential resources” mean that demand for resources exponentially increases with increase of a quantity of qubits, and the exponential resources may mean that a total quantity of quantum circuits to be measured is exponential, that is, exponential calculation time is required accordingly.

9. Pauli string: A general Hamiltonian can usually be decomposed into a sum of a set of Pauli strings for a term composed of Cartesian products of a plurality of Pauli operators of different lattice points. The VQE is usually decomposed according to the Pauli string and measured term by term.

10. Pauli operator: It is also referred to as a Pauli matrix, is a group of three 2×2 unitary Hermitian complex matrices (also referred to as unitary matrices), and is generally represented by a Greek letter σ (Sigma). A Pauli X operator is

$${σ}_{x} = [ \begin{matrix}0 & 1 \\ 1 & 0\end{matrix} ] ,$$

a Pauli Y operator is

$${σ}_{y} = [ \begin{matrix}0 & - i \\ i & 0\end{matrix} ] ,$$

and a Pauli Z operator is

$${σ}_{z} = [ \begin{matrix}1 & 0 \\ 0 & - 1\end{matrix} ] .$$

Obtaining a ground state of a quantum system represents obtaining a most stable state of the quantum system, which has very important applications in study of basic properties of quantum physics and quantum chemistry systems, a solution to a combinatorial optimization problem, pharmaceutical research, and the like. An important application scenario of a quantum computer is to effectively solve or express the ground state of the quantum system. Currently, some research institutions and manufacturers are constantly studying new quantum computers, and are committed to exploring the solution to the ground state.

The following is descriptions of a solution to obtaining the ground state of the quantum system provided in the related art.

Solution 1: Solve the ground state of the quantum system through imaginary time evolution.

The imaginary time evolution is a basic method to solve the ground state of the quantum system.

A time-dependent Schrödinger equation is:

$$i \frac{\partial }{\partial t} ψ ( r , t ) = H ψ ( r , t ) ;$$

H is a Hamiltonian of a target quantum system, ψ(r, t) represents a quantum state of the target quantum system at a moment of t, and i is an imaginary unit.

A stationary state Schrödinger equation is:

Hϕᵢ(r)=Eᵢϕᵢ(r);

ϕᵢ(r)(r=1,2,3 . . . ) is an eigenstate, and corresponds to eigenenergy Eᵢ. E₀≤E₁≤E₂≤E₃ . . . , E₀ is ground state energy. Imaginary time is defined as τ=it, then an imaginary time Schrödinger equation is:

$$\frac{\partial }{\partial t} ψ ( r , t ) = - H ψ ( r , t ) .$$

In order to calculate the ground state of the target quantum system, an initial state τ=0 is randomly given when ψ(r,0), which can be written as superposition of an eigenstate ψ(r,0)=Σᵢcᵢϕᵢ(r), and cᵢ is an expansion factor.

A wave function at τ is:

$$ψ ( r , τ ) = {e}^{- H τ} ψ ( r , 0 ) = {\sum }_{i} {c}_{i} {e}^{- {E}_{i} τ} {ϕ}_{i} ( r ) = {e}^{- {E}_{0} τ} [ {c}_{0} {ϕ}_{0} + {\sum }_{i = 1} {c}_{i} {e}^{- ( {E}_{i} - {E}_{0} ) τ} {ϕ}_{i} ( r ) ] .$$

Because Eᵢ≥E₀, along with evolution of ψ(r,τ), compared with ϕ₀, other states decay faster, and only the ground state is left in the end.

Solution 2: Variational quantum eigensolver (VQE).

The VQE is a fault-tolerant quantum algorithm that can run on an NISQ quantum devices and can simulate the ground state of the target quantum system.

An initial quantum state |ψ₀ [symbol] is given. Generally, an all-zero state, a uniform superposition state, or a Hartree-Fock state may be considered, and may be written as a linear combination of the eigenstate. A parameterized quantum circuit U(θ) is provided, so that U(θ)|ψ₀ [symbol] =|ψ(θ) [symbol] . As long as a quantum state space expressed by the parameterized quantum circuit includes the ground state of the target quantum system, a process of solving the ground state E₀ of the target quantum system can be transformed into an optimization process of a parameter in the quantum circuit:

$${E}_{0} = {min}_{θ} 〈 ψ ( θ \vert H \vert ψ ( θ ) 〉 .$$

A set of optimal θ may be found through a gradient descent method. Then, the parameterized quantum circuit is updated, to obtain an eigenstate ϕ₀ corresponding to the ground state energy.

Solution 3: Solve the ground state of the quantum system through variational imaginary time evolution.

In the variational imaginary time evolution, a process of imaginary time evolution is simulated by using a variational method combining classical and quantum, so as to solve the ground state of the target quantum system.

An initial state |ψ(0) [symbol] is provided, and the imaginary time evolution is defined as:

|ψ(τ) [symbol] =A(τ)e^{-Hτ}|ψ(0) [symbol] .

$$A ( τ ) = \frac{1}{\sqrt{〈 ψ ( θ ) \vert {e}^{- 2 H τ} \vert ψ ( θ ) 〉}}$$

is a normalization factor.

Wick rotation Schrödinger equation is:

$$\frac{\partial \vert ψ ( τ ) 〉}{\partial t} = - ( H - {E}_{τ} ) \vert ψ ( τ ) 〉 .$$

E_{τ}= [symbol] ψ(τ)|H|ψ(τ) [symbol] . Then, a trial wavefunction |ϕ(θ(τ)) [symbol] with a parameter is used for approximating |ψ(τ) [symbol] , to obtain:

|ϕ(θ) [symbol] =V(θ)|ψ(0) [symbol] .

This simulation can be achieved through McLachlan's variational principle:

$$δ ‖ ( \frac{\partial }{\partial t} + H - {E}_{τ} ) \vert ψ ( τ ) 〉 ‖ = 0.$$

The solution 1 described above, that is, the method of solving the ground state of the quantum system through the imaginary time evolution, has a clear theory for solving the ground state, which makes a process of approaching the ground state theoretically guaranteed. But e^{-Hτ} it uses is non-unitary, and cannot be directly decomposed into a single bit gate or a double bit gate which is applicable to a quantum circuit.

In the solution 2 described above, the VQE needs to assume a reasonable and reliable parameterized quantum circuit, causing a quantum state space expressed by the VQE to cover the target quantum state. Moreover, as a quantum system becomes more and more complex, a trial quantum circuit becomes deeper and deeper, and a parameter space is very large. Because an optimization space is very complex and is easy to fall into a local optimal solution, the ground state cannot be obtained.

According to the solution 3 described above, the method of solving the ground state of the quantum system through the variational imaginary time evolution, the parameterized quantum circuit is used for simulating the imaginary time evolution process. The evolution process needs to be slow enough, to optimize the parameter of the quantum circuit step by step, and to ensure that an accurate ground state is finally obtained.

This disclosure provides a new technical solution, to implement effective ground state simulation through a non-Hermitian simulation idea. The method has a good reference value for both a ground state simulation method put forward theoretically to reduce difficulty of operation and design of scientists in a recent NISQ stage, and ground state simulation for multi-bit and high-quality quantum hardware that may be implemented in the future.

In addition, the method for obtaining a ground state of a quantum system provided in this disclosure, may be implemented through a quantum computer, or in a mixed device environment of a classic computer and the quantum computer. For example, the classic computer and the quantum computer cooperate to implement the method. In the mixed device environment of the classic computer and the quantum computer, the classic computer executes a computer program to implement some classical calculations and control for the quantum computer, and the quantum computer implements operation such as controlling and measuring qubits. In the following method embodiment, for ease of description, the description is provided by merely using a computer device as the execution body of the steps. It is to be understood that the computer device may be the quantum computer, or may be a mixed execution environment including the classic computer and the quantum computer. This is not limited in the embodiments of this disclosure.

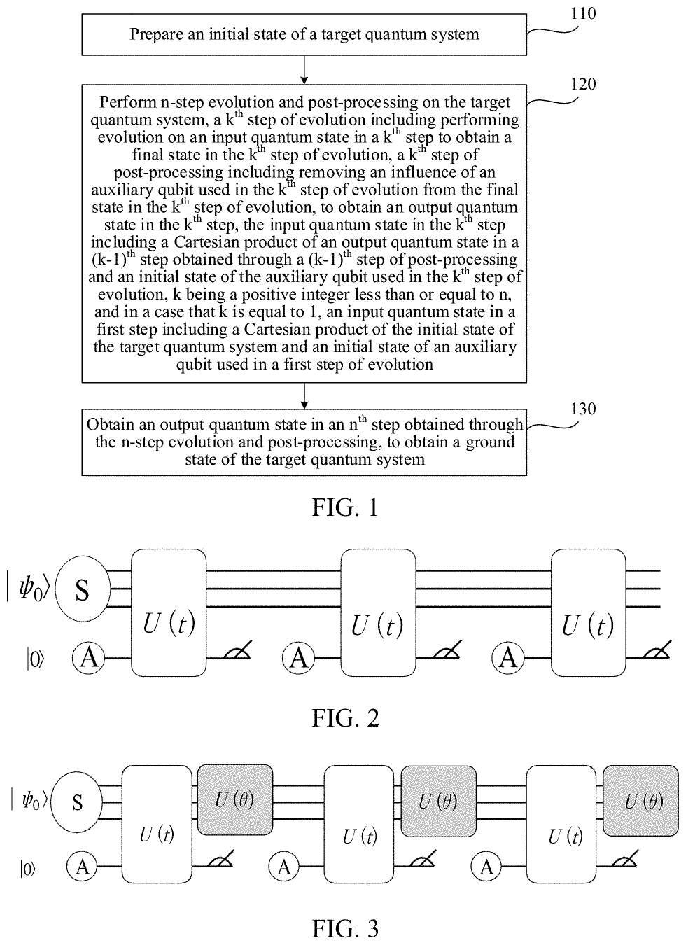

FIG. 1 is a flowchart of a method for obtaining a ground state of a quantum system according to an embodiment of this disclosure. The method may include the following steps (110 to 130):

In step 110, an initial state of a target quantum system is prepared.

In step 120, an n-step evolution and post-processing operation is performed on the target quantum system, a k^{th} step of evolution including performing evolution on an input quantum state in a k^{th} step to obtain a final state in the k^{th} step of evolution, a k^{th} step of post-processing including removing an influence of an auxiliary qubit used in the k^{th} step of evolution from the final state in the k^{th} step of evolution, to obtain an output quantum state in the k^{th} step, the input quantum state in the k^{th} step including a Cartesian product of an output quantum state in a (k−1)^{th} step obtained through a (k−1)^{th} step of post-processing and an initial state of the auxiliary qubit used in the k^{th} step of evolution, k being a positive integer less than or equal to n, and in a case that k is equal to 1, an input quantum state in a first step including a Cartesian product of the initial state of the target quantum system and an initial state of an auxiliary qubit used in a first step of evolution.

In step 130, an output quantum state from an n^{th} step is obtained through the n-step evolution and post-processing operation, to obtain a ground state of the target quantum system.

This disclosure designs a non-Hermitian quantum simulation algorithm to obtain the ground state of the target quantum system. The target quantum system refers to any quantum system whose ground state is to be obtained, and may be a quantum physical system or a quantum chemical system. This is not limited in this disclosure.

This disclosure designs a quantum circuit structure as shown in FIG. 2, on which the ground state of the target quantum system is obtained by implementing a quantum process similar to virtual and real evolution. In FIG. 2, “S” refers to a qubit space corresponding to a to-be-studied quantum system (that is, the target quantum system), and “A” refers to a qubit space corresponding to the auxiliary qubit. The n-step evolution and post-processing are performed on the target quantum system. Each step of evolution and post-processing includes executing an evolution process first and then executing a post-processing process. That is, a first step of evolution, a first step of post-processing, a second step of evolution, a second step of post-processing, . . . , an n^{th} step of evolution, and an n^{th} step of post-processing are sequentially performed.

In the embodiments of this disclosure, an input quantum state in the k^{th} step of evolution is referred to as an input quantum state in the k^{th} step. For example, an input quantum state in the first step of evolution is referred to as an input quantum state in the first step. In each step of the evolution process, the auxiliary qubit is used for helping implementing a unitary evolution process. In some examples, one auxiliary qubit is used in each step of the n-step evolution, and the auxiliary qubit is recycled in the n-step evolution. The k^{th} step of evolution including performing evolution on an input quantum state in a k^{th} step to obtain a final state in the k^{th} step of evolution. The input quantum state in the k^{th} step includes a Cartesian product of an output quantum state in a (k−1)^{th} step obtained through a (k−1)^{th} step of post-processing and an initial state of the auxiliary qubit used in the k^{th} step of evolution. For the first step of evolution (that is, k=1), the first step of evolution includes performing evolution on the input quantum state in the first step to obtain the final state in the first step of evolution. An input quantum state in the first step includes a Cartesian product of the initial state of the target quantum system and an initial state of an auxiliary qubit used in the first step of evolution.

In some examples, each step of the evolution process is implemented through a quantum circuit. For the k^{th} step of evolution, evolution is performed on the input quantum state in the k^{th} step by using a k^{th} quantum circuit, to obtain the final state in the k^{th} step of evolution. In some examples, each step of the post-processing process is implemented through a measuring circuit. For the k^{th} step of post-processing, a k^{th} measuring circuit is used for performing classical data post-processing on the final state in the k^{th} step of evolution, and projecting the auxiliary qubit used in the k^{th} step of evolution to a 0 state, to obtain the output quantum state in the k^{th} step.

As shown in FIG. 2, the quantum circuit used in the evolution process is represented by U(t). U(t)=e^{-iHt}, H=H_{S}⊗σ_{x/y}^{A}. ⊗ represents a Cartesian product of two matrices, H_{S} represents a Hamiltonian of the target quantum system, and σ_{x/y}^{A} represents a Pauli operator acting on the auxiliary qubit. The Pauli operator may be a Pauli X operator

$${σ}_{x}^{A} ( {σ}_{x}^{A} = [ \begin{matrix}0 & 1 \\ 1 & 0\end{matrix} ] ) ,$$

or a Pauli Y operator

$${σ}_{y}^{A} ( {σ}_{y}^{A} = [ \begin{matrix}0 & - i \\ i & 0\end{matrix} ] ) ,$$

and t represents time.

In some examples, the initial state of the target quantum system is prepared as |ψ₀ [symbol] , and the initial state of the auxiliary qubit is prepared as |0 [symbol] , that is, an input quantum state |ϕ₀ [symbol] =|ψ₀ [symbol] |0 [symbol] in the first step corresponding to the first step of evolution. The input quantum state |ϕ₀ [symbol] in first step implements unitary evolution through a quantum circuit U(t), to obtain the final state |ϕ₁ [symbol] of the first step of evolution:

|ϕ₁ [symbol] =U(t)|ψ₀ [symbol] |0

[symbol]

=cos(H_{S}t)|ψ₀ [symbol] |0 [symbol] −i sin(H_{S}t)⊗σ_{x/y}^{A}|ω₀ [symbol] |0 [symbol] .

=cos(H_{S}t)|ψ₀ [symbol] |0 [symbol] +sin(H_{S}t)|ψ₀ [symbol] |1

[symbol]

The final state |ϕ₁ [symbol] of the first step of evolution is then performed classical data post-processing through the measuring circuit (not shown in FIG. 2), and the auxiliary qubit is projected to |0 [symbol] , to obtain an output quantum state |ϕ′₁ [symbol] in the first step:

|ϕ′₁ [symbol] =PU(t)|ψ₀ [symbol] |0 [symbol] =cos(H_{S}t)|ψ₀ [symbol] |0 [symbol] .

P is a projection operator,

$$P = \frac{1}{2} ( 1 + {σ}_{z}^{A} ) , {σ}_{z}^{A} = [ \begin{matrix}1 & 0 \\ 0 & - 1\end{matrix} ]$$

is a Pauli operator acting on the auxiliary qubit, and the Pauli operator is a Pauli Z operator.

In the same way, it can be deduced that a final state |ϕₙ [symbol] of the n^{th} step of evolution obtained through the n-step evolution is:

|ϕₙ [symbol] =U(t)ⁿ|ω₀ [symbol] 00 . . . 0

[symbol]

=cosⁿ(H_{S}t)|ψ₀ [symbol] |00 . . . 0 [symbol] +cosⁿ⁻¹(H_{S}t)sin(H_{S}t)|ψ₀ [symbol] |00 . . . 1)+ . . . +sinⁿ(H_{S}t)|ψ₀ [symbol] |11 . . . 1

[symbol]

An n^{th} measuring circuit is used for performing classical data post-processing on the final state |ϕₙ [symbol] of the n^{th} step of evolution. The auxiliary qubit is projected to |0 [symbol] , to obtain an output quantum state |ϕ′ₙ [symbol] in the n^{th} step:

|ϕ′ₙ [symbol] PU(t)ⁿ|ψ₀ [symbol] |00 . . . 0 [symbol] =cosⁿ(H_{S}t)|ψ₀ [symbol] |00 . . . 0 [symbol] .

P is a projection operator,

$$P = \frac{1}{{2}^{n}} ( 1 + {σ}_{z}^{{A}_{1}} ) ( 1 + {σ}_{z}^{{A}_{2}} ) ⋯ ( 1 + {σ}_{z}^{{A}_{n}} ) , {σ}_{z}^{{A}_{k}}$$

represents a Pauli operator acting on the auxiliary qubit used in k^{th} step of evolution, and the Pauli operator is a Pauli Z operator.

After the foregoing n-step evolution and post-processing, an output quantum state |ϕ′ₙ [symbol] in the n^{th} step of evolution is finally obtained, and is the ground state of the target quantum system.

Further, an energy eigenvalue Eₙ (that is, ground state energy E of the target quantum system) corresponding to the output quantum state |ϕ′ₙ [symbol] in the n^{th} step:

$$E = {E}_{n} = \frac{〈 {ϕ}_{n}^{′} \vert {H}_{S} \vert {ϕ}_{n}^{′} 〉}{〈 {ϕ}_{n}^{′} \vert {ϕ}_{n}^{′} 〉} = \frac{〈 {ϕ}_{n}^{′} \vert {PH}_{S} \vert {ϕ}_{n}^{′} 〉}{〈 {ϕ}_{n}^{′} \vert P \vert {ϕ}_{n}^{′} 〉} .$$

P²=P and [P, H_{S}]=0 (indicating that P and H_{S} are commutative) are used. It can be found that according to a property of a cos function, for a single-step evolution time scale t with appropriate length, the following condition is met:

cos(E_{g}t)>cos(E_{k≠g}t)>0,0<E_{g}<E_{k≠g}

E_{g} represents ground state energy, and E_{k≠g} represents non-ground state energy. For H_{S} whose eigenspectrum is not positive, the eigenspectrum can be translated to positive through H_{S}+λI_{S}. After lowest energy E′_{g} is obtained, E_{g}=E′_{g}−λ is reversely deduced. λ is a translation parameter determined by prediction, and I_{S} is an identity matrix.

After the foregoing n-step evolution, Cos(E_{g}t)>cos(E_{k≠g}t)>0. Therefore, an effective non-Hermitian quantum simulation algorithm is obtained, which has an effect similar to virtual and real evolution, that is: With gradual increase of evolution steps, a proportion of the ground state of the target quantum system becomes larger and larger, while a proportion of an excited state becomes smaller and smaller, and finally the ground state of the target quantum system is obtained.

In the foregoing process, technical solutions provided in this disclosure naturally show the following advantages: 1) An effect of virtual and real evolution is achieved by using real-time unitary evolution related to a Hamiltonian of a system, which can be directly achieved through the quantum circuit. 2) The auxiliary qubit used in each step of evolution can be recycled, that is, one auxiliary qubit is needed in total, which saves qubit resources. 3) It does not depend on the variational quantum circuit, and the optimization process is clearer and more stable in theory. 4) The classical data post-processing instead of related post-selection of measurement result is used, which reduces complexity of a quantum experiment at cost of consuming classical computing resources.

In order to implement that the quantum simulation algorithm provided in this disclosure follows an effect similar to the virtual and real quantum dynamics evolution in an operation process, this disclosure uses a method of real-time quantum dynamics evolution under the auxiliary qubit and then performing classical data post-processing, to obtain quantum evolution of the target quantum system:

|ψ_{T=nt} [symbol] =cosⁿ(H_{S}t)|ω₀ [symbol] .

It is necessary to calculate [symbol] ϕₙ|PH_{S}|ϕₙ [symbol] and [symbol] ϕₙ|P|ϕₙ [symbol] when the energy eigenvalue is obtained, and

$$P = \frac{1}{{2}^{n}} ( 1 + {σ}_{z}^{{A}_{1}} ) ( 1 + {σ}_{z}^{{A}_{2}} ) ⋯ ( 1 + {σ}_{z}^{{A}_{n}} ) ,$$

n being a quantity of steps of dynamics evolution. It is not difficult to see that, as a quantity of steps n increases, a combination term of Pauli matrix in P exponentially (2ⁿ) increases, that is, classical computational complexity presents 2ⁿ exponential growth. Therefore, this disclosure further provides an alternative solution to the classical data post-processing.

Because the projection operator P meets P²=P and [P, H_{S}]=0, it can be proved that:

[symbol]

ψ₁|z₁|ψ₁ [symbol] = [symbol] ψ₂|z₁I₂|ψ₂ [symbol] = [symbol] ψ₃|z₁I₂I₃|ψ₃ [symbol] = . . . ;

[symbol]

ψ₁|H_{S}Z₁|ψ₁ [symbol] = [symbol] ψ₂|H_{S}Z₁I₂|ψ₂ [symbol] = [symbol] ψ₃|H_{S}Z₁I₂I₃|ψ₃ [symbol] = . . . .

Because [symbol] ψₙ|Zₖ|ψₙ [symbol] = [symbol] ψ₀|e^{iH}^{_{S}}^{⊗Y}^{ₖ}Zₖe^{-iH}^{_{S}}^{⊗Y}^{ₖ}|ψ₀ [symbol] it can be proved that:

$$〈 {ψ}_{n} \vert {Z}_{1} \vert {ψ}_{n} 〉 = 〈 {ψ}_{n} \vert {Z}_{2} \vert {ψ}_{n} 〉 = 〈 {ψ}_{n} \vert {Z}_{3} \vert {ψ}_{n} 〉 = … ; \\ 〈 {ψ}_{n} \vert {Z}_{1} {Z}_{2} \vert {ψ}_{n} 〉 = 〈 {ψ}_{n} \vert {Z}_{1} {Z}_{3} \vert {ψ}_{n} 〉 = 〈 {ψ}_{n} \vert {Z}_{2} {Z}_{3} \vert {ψ}_{n} 〉 = … ; \\ …… \\ 〈 {ψ}_{n} \vert {Z}_{1} {Z}_{2} … {Z}_{n} \vert {ψ}_{n} 〉 .$$

In addition, because [symbol] ψₙ|H_{S}Zₖ|ωₙ [symbol] = [symbol] ψ₀|^{iH}^{_{S}}^{⊗Y}^{ₖ}H_{S}Zₖe^{-iH}^{_{S}}^{⊗Y}^{ₖ}_{ψ} [symbol] , it can be proved that:

$$〈 {ψ}_{n} \vert {H}_{S} {Z}_{1} \vert {ψ}_{n} 〉 = 〈 {ψ}_{n} \vert {H}_{S} {Z}_{2} \vert {ψ}_{n} 〉 = 〈 {ψ}_{n} \vert {H}_{S} {Z}_{3} \vert {ψ}_{n} 〉 = … ; \\ 〈 {ψ}_{n} \vert {H}_{S} {Z}_{1} {Z}_{2} \vert {ψ}_{n} 〉 = 〈 {ψ}_{n} \vert {H}_{S} {Z}_{1} {Z}_{3} \vert {ψ}_{n} 〉 = 〈 {ψ}_{n} \vert {H}_{S} {Z}_{2} {Z}_{3} \vert {ψ}_{n} 〉 = … ; \\ …… \\ 〈 {ψ}_{n} \vert {H}_{S} {Z}_{1} {Z}_{2} … {Z}_{n} \vert {ψ}_{n} 〉 .$$

Therefore, an energy expectation value corresponding to evolution steps n may be finally written as:

$$\begin{matrix}E = \frac{〈 {ψ}_{n} \vert {PH}_{S} \vert {ψ}_{n} 〉}{〈 {ψ}_{n} \vert P \vert {ψ}_{n} 〉} \\ = \frac{\begin{matrix}{C}_{n}^{0} 〈 {ψ}_{0} \vert {H}_{S} \vert {ψ}_{0} 〉 + {C}_{n}^{1} 〈 {ψ}_{1} \vert {H}_{S} {Z}_{1} \vert {ψ}_{1} 〉 + {C}_{n}^{2} 〈 {ψ}_{2} \vert {H}_{S} {Z}_{1} {Z}_{2} \vert {ψ}_{2} 〉 + ⋯ + \\ {C}_{n}^{n} 〈 {ψ}_{n} \vert {H}_{S} {Z}_{1} {Z}_{2} … {Z}_{n} \vert {ψ}_{n} 〉\end{matrix}}{\begin{matrix}{C}_{n}^{0} 〈 {ψ}_{0} \vert {ψ}_{0} 〉 + {C}_{n}^{1} 〈 {ψ}_{1} \vert {Z}_{1} \vert {ψ}_{1} 〉 + {C}_{n}^{2} 〈 {ψ}_{2} \vert {Z}_{1} {Z}_{2} \vert {ψ}_{2} 〉 + ⋯ + \\ {C}_{n}^{n} 〈 {ψ}_{n} \vert {Z}_{1} {Z}_{2} … {Z}_{n} \vert {ψ}_{n} 〉\end{matrix}} .\end{matrix}$$

In this way, for a result of an n^{th} step, only two terms need to be calculated: [symbol] ψₙ|H_{S}Z₁Z₂ . . . Zₙ|ψₙ) and (ψₙ|Z₁Z₂ . . . Zₙ|ψₙ), thereby greatly reducing calculation amount. It can be inferred that complexity of energy eigenvalue calculation increases linearly with the evolution steps by 2n.

In conclusion, according to the technical solutions provided in the embodiments of this disclosure, the target quantum system is gradually evolved from the initial state to the ground state by performing multi-step evolution and post-processing on the target quantum system, to obtain the ground state of the target quantum system. In the evolution process, the auxiliary qubit is introduced to implement unitary evolution, thereby providing a quantum simulation algorithm based on a non-Hermitian process, to simulate the ground state of the target quantum system. A real-time unitary evolution related to a Hamiltonian of the system is used for achieving an effect of virtual and real evolution, thus implementing simulation of the ground state of the target quantum system in theory. In addition, this process can be directly implemented by using a quantum circuit, which fully improves operability of the solution.

In addition, the auxiliary qubit used in each step of evolution can be recycled, that is, one auxiliary qubit is needed in total, which saves quantum computing resources.

Because if a Hamiltonian of the target quantum system is larger in scale and more complex in form, the evolution steps to obtain its ground state may be longer, which means a deeper quantum circuit. This exerts pressure on a recent medium-sized quantum chip with noise. In order to further improve efficiency of ground state simulation and better apply to quantum hardware at present, according to an exemplary embodiment of this disclosure, a non-Hermitian evolutionary algorithm is skillfully combined with a variational quantum circuit structure. In some examples, the quantum circuit used in each step of evolution is followed by a variational quantum circuit. As shown in FIG. 3, “S” refers to a qubit space corresponding to a to-be-studied quantum system (that is, the target quantum system), and “A” refers to a qubit space corresponding to the auxiliary qubit. U(t) represents the quantum circuit used in the evolution process, U(t)=e^{-iHt}, H=H_{S}⊗σ_{x/y}^{A}. ⊗ represents a Cartesian product of two matrices, H_{S} represents a Hamiltonian of the target quantum system, and σ_{x/y}^{A} represents a Pauli operator acting on the auxiliary qubit. The Pauli operator may be a Pauli X operator

$${σ}_{x}^{A} ( {σ}_{x}^{A} = [ \begin{matrix}0 & 1 \\ 1 & 0\end{matrix} ] ) ,$$

or a Pauli Y operator

$${σ}_{y}^{A} ( {σ}_{y}^{A} = [ \begin{matrix}0 & 1 \\ 1 & 0\end{matrix} ] ) ,$$

and t represents time. U(θ) is an introduced variational quantum circuit, so that after each layer is performed evolution operation through U(t), U(θ) is further optimized. Using a first layer as an example, an optimization goal of U(θ) is to adjust a parameter of U(O), to cause

$${min}_{θ} 〈 {ϕ}_{1} \vert {U}^{†} ( θ ) {H}_{S} U ( θ ) \vert {ϕ}_{1} 〉 .$$

Using a k^{th} step of evolution and post-processing process as an example, after the final state in the k^{th} step of evolution is obtained, a variational quantum circuit corresponding to the k^{th} step of evolution is used for performing transformation on the final state in the k^{th} step of evolution, to obtain a quantum state after a k^{th} step of transformation. A parameter of the variational quantum circuit corresponding to the k^{th} step of evolution is adjusted, so that an energy expectation value of the quantum state after the k^{th} step of transformation is minimized. In a case that the parameter of the variational quantum circuit corresponding to the k^{th} step of evolution meets a stop optimization condition, the quantum state after the k^{th} step of transformation is obtained. The k^{th} step of post-processing is performed on the quantum state after the k^{th} step of transformation, to obtain the output quantum state in the k^{th} step.

In this way, on the one hand, U(t) is a powerful driving force to make the quantum state evolve to the ground state, and does not rely on parameter optimization of a variational structure. On the other hand, it is also a reliable driving force to jump out of variational optimization and lead to a local optimal solution. With auxiliary of U(θ), by introducing a certain degree of variation, the quantum state is led to a lower energy more quickly, which greatly helps to reduce a quantity of modules of U(t) needed originally, that is, depth of the quantum circuit is reduced.

In some examples, a parameter optimization strategy of updating the variational quantum circuit layer by layer is used, to control a quantity of parameters whose variation in is implemented in a small space as possible, and to create a simpler optimization surface, which is more conducive to obtaining a current global optimal solution. For example, in a process of adjusting the parameter of the variational quantum circuit corresponding to the k^{th} step of evolution, a parameter of a variational quantum circuit corresponding to another step of evolution is kept unchanged. After the adjusting the parameter of the variational quantum circuit corresponding to the k^{th} step of evolution is completed, a parameter of a variational quantum circuit corresponding to a (k+1)^{th} step of evolution is adjusted.

In a circuit structure shown in FIG. 3, an example in which each quantum circuit U(t) is followed by a variational quantum circuit U(θ) is used only. In some other embodiments, some U(t) may be followed by U(θ), and other U(t) may not be followed by U(θ). This is not limited in this disclosure.

In this embodiment, by combining a simple variational quantum circuit, the non-Hermitian evolution algorithm is combined with the variational quantum circuit structure, which is helpful to reduce the depth of the quantum circuit, and can further improve hardware efficiency of simulation.

In the foregoing embodiments, the quantum circuit U(t)=e^{-iHt} used in evolution is usually approximately expressed by using Trotter decomposition, and operations of a series of single-bit and double-bit quantum gates in real circuit operation:

$${e}^{- iHt} \approx {( {e}^{- \frac{{iH}_{1} t}{n}} {e}^{- \frac{{iH}_{2} t}{n}} ⋯ {e}^{- \frac{{iH}_{K} t}{n}} )}^{n} .$$

$$H = {\sum }_{i}^{K} {H}_{i} \cdot {e}^{- \frac{{iH}_{i} t}{n}}$$

may be expressed as operations of single-bit and double-bit quantum gates. The Hamiltonian of the target quantum system may be decomposed as a sum of a series of Pauli strings. K is a number of terms in the Pauli string obtained by decomposing the Hamiltonian. H; refers to a Hamiltonian corresponding to one term of the Pauli strings. It is not difficult to see that the more complex the target quantum system H is, the deeper a quantum circuit U(t) corresponding to single-step evolution is. In addition, a plurality of quantum evolution steps mean a plurality of U(t), that is, deeper and deeper quantum circuits. For a current development stage of a quantum computing chip, depth of a quantum circuit gate is still greatly limited by hardware noise. In order to better show an advantage of the algorithm of this disclosure on a complex issue, this disclosure provides another exemplary embodiment, in which efficiency of hardware usage is further improved by using a method of compressing the quantum states by using the variational quantum circuit.

In an exemplary embodiment, the n-step evolution and post-processing described above are alternatively implemented by using the following methods:

1. constructing a trial quantum state by using a target variational quantum circuit;

2. adjusting a parameter of the target variational quantum circuit so that the trial quantum state approaches a target quantum state;

3. determining the trial quantum state constructed by the target variational quantum circuit as the ground state of the target quantum system in a case that the parameter of the target variational quantum circuit meets a stop optimization condition; and determining an energy expectation value of a Hamiltonian of the target quantum system under the trial quantum state as ground state energy of the target quantum system.

The quantum state is compressed by the variational quantum circuit. That is, a trial quantum state |ψ(ωₜ) [symbol] is constructed by using a quantum circuit (that is, the “target variational quantum circuit”, which alternatively implements functions of the quantum circuit U(t) (in some examples, and the variational quantum circuit U(θ))) with an appropriate quantity of to-be-optimized parameters and a medium scale. Then its parameters are optimized to be as close to the target quantum state |ϕ(t)) as possible. ωₜ∈R^{p} is an P-dimensional vector composed of parameters. Quantum state evolution starting from a moment t to a next moment t+dt can be written as:

|ϕ(t+dt) [symbol] =e^{-iHdt}|ψ(ωₜ) [symbol] .

Then ω_{t+dt} is optimized to cause:

$${max}_{{ω}_{t + dt}} {\vert 〈 ψ ( {ω}_{t + dt} ) \vert {e}^{- iHdt} \vert ψ ( {ω}_{t} ) 〉 \vert}^{2} .$$

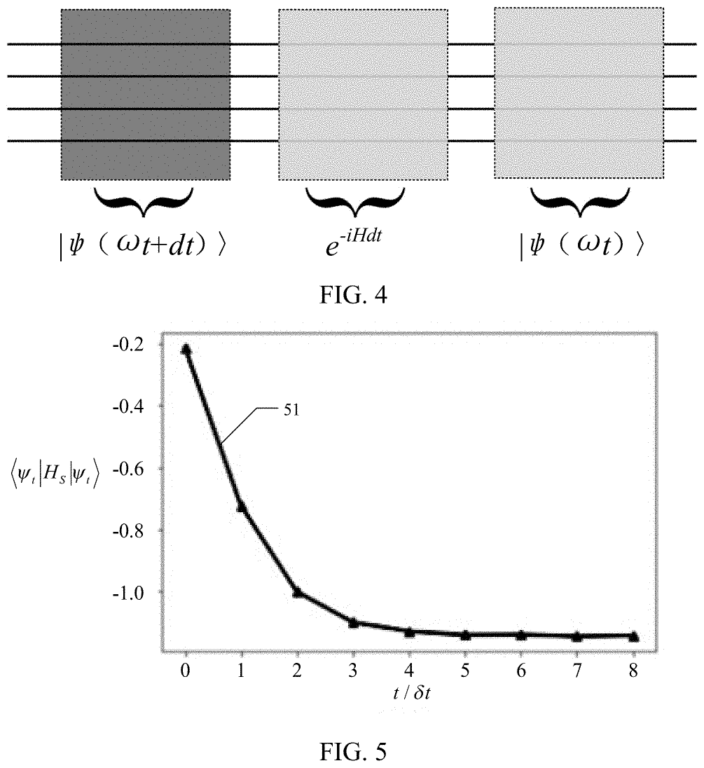

This calculation can be obtained through the quantum circuit shown in FIG. 4.

Finally, starting from the initial state |ϕ(t₀) [symbol] , through a plurality of steps of quantum evolution, a circuit compressed version of the quantum state |ψ(ω_{T}) [symbol] corresponding to the final state |ϕ(t_{T=NT})) is obtained.

Some experiments completed by using technical solutions of this disclosure are described below.

The non-Hermitian quantum simulation algorithm provided in this disclosure is used for simulating a ground state of a hydrogen molecule (H₂). A quantum computing process shown in FIG. 2 is used. A Hamiltonian H_{S} of the hydrogen molecule under a Pauli basis is:

H_{S}=g₀+g₁Z₁+g₂Z₂+g₃Z₁Z₂+g₄X₁X₂+g₅Y₁Y₂.

$${X}_{i} = ( \begin{matrix}0 & 1 \\ 1 & 0\end{matrix} ) , {Y}_{i} = ( \begin{matrix}0 & - i \\ i & 0\end{matrix} ) , and {Z}_{i} = ( \begin{matrix}1 & 0 \\ 0 & - 1\end{matrix} )$$

are all Pauli operators, i=1 or 2. Set g₀=0.2252, g₁=0.3435, g₂=−0.4347, g₃=0.5716, g₄=0.0910, and g₅=0.0910. The ground state of the target quantum system is prepared as

$$\vert {ψ}_{0} 〉 = \frac{1}{\sqrt{2}} ( 1 , 1 ) .$$

A dynamics evolution step size dt=0.2. Quantum simulation is performed on an IBMQ simulator, to obtain a result shown in FIG. 5.

Line 51 in FIG. 5 shows that an energy expectation value of the target quantum system gradually decreases with the evolution steps. The ground state energy is reached in steps n=7, and the ground state simulation is successfully achieved.

The non-Hermitian quantum simulation algorithm provided in this disclosure is further applied to simulate a ground state of a one-dimensional transverse field Ising model. A quantum computing process shown in FIG. 2 and FIG. 3 is used. A Hamiltonian H_{S} of a transverse field Ising model with four lattice points is:

$${H}_{S} = a {\sum }_{〈 i , j 〉} {Z}_{i} {Z}_{j} + h {\sum }_{i} {X}_{i} .$$

Both

$${X}_{i} = ( \begin{matrix}0 & 1 \\ 1 & 0\end{matrix} ) , and {Z}_{i} = {Z}_{j} = ( \begin{matrix}1 & 0 \\ 0 & - 1\end{matrix} ) ,$$

are Pauli operators. Zᵢ and Zⱼ are Pauli operators representing different lattice points. Set a=h=1/\sqrt{2}. The ground state of the target quantum system is prepared as

$$\vert {ψ}_{0} 〉 = \frac{1}{2} ( 1 , 1 , 1 , 1 ) .$$

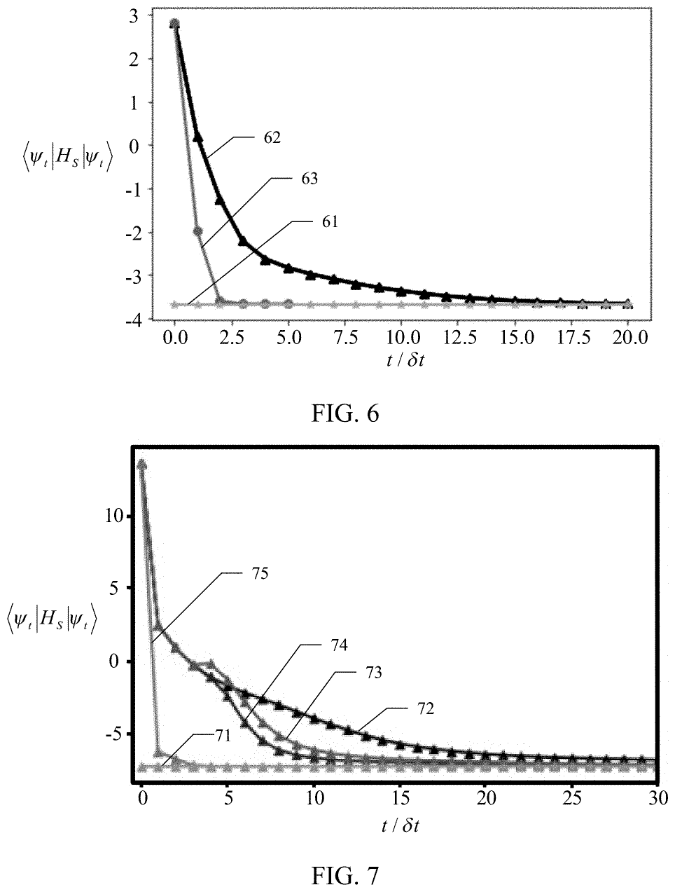

dynamics evolution step size dt=0.2. Quantum simulation is performed on an IBMQ simulator, to obtain a result shown in FIG. 6.

FIG. 6 shows that the energy expectation value of the target quantum system gradually decreases with the evolution steps. Line 61 is a result of its exact ground state, line 62 is a result obtained by using the quantum computing process shown in FIG. 2, and line 63 is a result obtained by using the quantum computing process shown in FIG. 3. It can be seen that: 1) Both algorithms in FIG. 2 and FIG. 3 can implement simulation for a ground state of a target Hamiltonian. 2) A speed of implementing the ground state can be accelerated in combination with the variational quantum circuit, and the evolution steps are greatly reduced to 3 steps.

Finally, the non-Hermitian quantum simulation algorithm provided in this disclosure is further applied to simulate a ground state of a one-dimensional transverse field Ising model with 8 lattice points. A quantum computing process shown in FIG. 2 and FIG. 3 is used. A Hamiltonian H_{S} of a transverse field Ising model with eight lattice points is:

$${H}_{S} = a {\sum }_{〈 i , j 〉} {Z}_{i} {Z}_{j} + h {\sum }_{i} {X}_{i} .$$

Both

$${X}_{i} = ( \begin{matrix}0 & 1 \\ 1 & 0\end{matrix} ) , and {Z}_{i} = {Z}_{j} = ( \begin{matrix}1 & 0 \\ 0 & - 1\end{matrix} )$$

are Pauli operators. Zᵢ and Zⱼ are Pauli operators representing different lattice points. Set a=h=1/\sqrt{2}. The ground state of the target quantum system is prepared as

$$\vert {ψ}_{0} 〉 = \frac{1}{2 \sqrt{2}} ( 1 , 1 , 1 , 1 , 1 , 1 , 1 , 1 ) .$$

A dynamics evolution step size dt=0.2. Quantum simulation is performed on an IBMQ simulator, to obtain a result shown in FIG. 7.

FIG. 7 shows that the energy expectation value of the target quantum system gradually decreases with the evolution steps. Line 71 is a result of its exact ground state, line 72, line 73, and line 74 are results obtained by using the quantum computing process shown in FIG. 2, and line 75 is a result obtained by using the quantum computing process shown in FIG. 3. It can be seen that: 1) Both algorithms in FIG. 2 and FIG. 3 can implement simulation for a ground state of a target Hamiltonian. 2) The evolution step size is gradually increased by using the algorithm in FIG. 2, which can accelerate a convergence speed. 3) A speed of implementing the ground state can be accelerated in combination with the variational quantum circuit, and the evolution steps are greatly reduced to 3 steps.

The following is an apparatus embodiment of this disclosure, which can be used to perform the method embodiments of this disclosure. For exemplary details not disclosed in the apparatus embodiments of this disclosure, refer to the method embodiments of this disclosure.

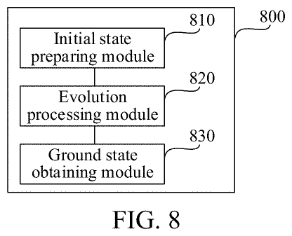

FIG. 8 is a block diagram of an apparatus for obtaining a ground state of a quantum system according to an embodiment of this disclosure. The apparatus has functions for implementing the foregoing method embodiments. The functions may be implemented by hardware, or may be implemented by hardware executing corresponding software. The apparatus may be the computer device described above, or may be disposed in the computer device. One or more modules, submodules, and/or units of the apparatus can be implemented by processing circuitry, software, or a combination thereof, for example. As shown in FIG. 8, an apparatus 800 may include: an initial state preparing module 810, an evolution processing module 820, and a ground state obtaining module 830.

The initial state preparing module 810 is configured to prepare an initial state of a target quantum system.

The evolution processing module 820 is configured to perform n-step evolution and post-processing on the target quantum system, a k^{th} step of evolution including performing evolution on an input quantum state in a k^{th} step to obtain a final state in the k^{th} step of evolution, a k^{th} step of post-processing including removing an influence of an auxiliary qubit used in the k^{th} step of evolution from the final state in the k^{th} step of evolution, to obtain an output quantum state in the k^{th} step, the input quantum state in the k^{th} step including a Cartesian product of an output quantum state in a (k−1)^{th} step obtained through a (k−1)^{th} step of post-processing and an initial state of the auxiliary qubit used in the k^{th} step of evolution, k being a positive integer less than or equal to n, and in a case that k is equal to 1, an input quantum state in a first step including a Cartesian product of the initial state of the target quantum system and an initial state of an auxiliary qubit used in a first step of evolution; and

The ground state obtaining module 830 is configured to obtain an output quantum state in an n^{th} step obtained through the n-step evolution and post-processing, to obtain a ground state of the target quantum system.

In an exemplary embodiment, the evolution processing module 820 is configured to:

perform, for the k^{th} step of evolution, evolution on the input quantum state in the k^{th} step by using a k^{th} quantum circuit, to obtain the final state in the k^{th} step of evolution; and

perform, for the k^{th} step of post-processing, classical data post-processing on the final state in the k^{th} step of evolution by using a k^{th} measuring circuit, and projecting the auxiliary qubit used in the k^{th} step of evolution to a 0 state, to obtain the output quantum state in the k^{th} step.

In an exemplary embodiment, a process of obtaining a final state |ϕₙ [symbol] of an n^{th} step of evolution through the n-step evolution is as follows:

|ϕₙ [symbol] =U(t)ⁿ|ψ₀ [symbol] |00 . . . 0

[symbol]

=cosⁿ(H_{S}t)|ψ₀ [symbol] 00 . . . 0)+cosⁿ⁻¹(H_{S}t)sin(H_{S}t)|ψ₀ [symbol] |00 . . . 1 [symbol] +sinⁿ(H_{S}t)|ψ₀ [symbol] |11 . . . 1 [symbol] ′

U(t) representing the quantum circuit used for evolution, |ψ₀ [symbol] representing the initial state of the target quantum system, U(t)=e^{-iHt}, H=H_{S}⊗σ_{x/y}^{A}, H_{S} representing a Hamiltonian of the target quantum system, σ_{x/y}^{A} representing a Pauli operator acting on the auxiliary qubit, and t representing time.

In an exemplary embodiment, a process of performing classical data post-processing on the final state |ϕₙ [symbol] of an n^{th} step of evolution is as follows:

|ϕ′ₙ [symbol] =PU(t)ⁿψ₀ [symbol] 00 . . . 0 [symbol] =cosⁿ(H_{S}t)|ψ₀ [symbol] 00 . . . 0 [symbol] ,

P being a projection operator,

$$P = \frac{1}{{2}^{n}} ( 1 + {σ}_{z}^{{A}_{1}} ) ( 1 + {σ}_{z}^{{A}_{2}} ) ⋯ ( 1 + {A}_{z}^{{A}_{n}} ) ,$$

and σ_{z}^{A}^{ₖ} representing a Pauli operator acting on the auxiliary qubit used in the k^{th} step of evolution.

In an exemplary embodiment, one auxiliary qubit is used in each step of the n-step evolution, and the auxiliary qubit is recycled in the n-step evolution.

In an exemplary embodiment, the evolution processing module 820 is further configured to:

perform, after the final state in the k^{th} step of evolution is obtained, transformation on the final state in the k^{th} step of evolution by using a variational quantum circuit corresponding to the k^{th} step of evolution, to obtain a quantum state after a k^{th} step of transformation;

adjust a parameter of the variational quantum circuit corresponding to the k^{th} step of evolution, so that an energy expectation value of the quantum state after the k^{th} step of transformation is minimized;

obtain, in a case that the parameter of the variational quantum circuit corresponding to the k^{th} step of evolution meets a stop optimization condition, the quantum state after the k^{th} step of transformation; and

perform the k^{th} step of post-processing on the quantum state after the k^{th} step of transformation, to obtain the output quantum state in the k^{th} step.

In an exemplary embodiment, the evolution processing module 820 is further configured to:

keep, in a process of adjusting the parameter of the variational quantum circuit corresponding to the k^{th} step of evolution, a parameter of a variational quantum circuit corresponding to another evolution step unchanged; and

adjust, after the adjusting the parameter of the variational quantum circuit corresponding to the k^{th} step of evolution is completed, a parameter of a variational quantum circuit corresponding to a (k+1)^{th} step of evolution.

In an exemplary embodiment, the n-step evolution and post-processing are alternatively implemented by using the following methods:

constructing a trial quantum state by using a target variational quantum circuit;

adjusting a parameter of the target variational quantum circuit so that the trial quantum state approaches a target quantum state; and

determining the trial quantum state constructed by the target variational quantum circuit as the ground state of the target quantum system in a case that a parameter of the target variational quantum circuit meets a stop optimization condition; and determining an energy expectation value of a Hamiltonian of the target quantum system under the trial quantum state as ground state energy of the target quantum system.

In an exemplary embodiment, the apparatus 800 further includes an energy calculating module (not shown in FIG. 8), which is configured to calculate the ground state energy E of the target quantum system according to the following formula:

$$E = \frac{〈 {ϕ}_{n}^{′} \vert {H}_{S} \vert {ϕ}_{n}^{′} 〉}{〈 {ϕ}_{n}^{′} \vert {ϕ}_{n}^{′} 〉} = \frac{〈 {ϕ}_{n}^{′} \vert {PH}_{S} \vert {ϕ}_{n}^{′} 〉}{〈 {ϕ}_{n}^{′} \vert P \vert {ϕ}_{n}^{′} 〉} ,$$

H_{S} representing the Hamiltonian of the target quantum system, |ϕₙ [symbol] representing the final state in the n^{th} step of evolution, |ϕ′ₙ [symbol] representing the output quantum state in the n^{th} step, P being the projection operator,

$$= \frac{1}{{2}^{n}} ( 1 + {σ}_{z}^{{A}_{1}} ) ( 1 + {σ}_{z}^{{A}_{2}} ) ⋯ ( 1 + {A}_{z}^{{A}_{n}} ) ,$$

and σ_{z}^{A}^{ₖ} representing the Pauli operator acting on the auxiliary qubit used in the k^{th} step of evolution.

In this disclosure, the target quantum system is gradually evolved from the initial state to the ground state by performing multi-step evolution and post-processing on the target quantum system, to obtain the ground state of the target quantum system. In the evolution process, the auxiliary qubit is introduced to implement unitary evolution, thereby providing a quantum simulation algorithm based on a non-Hermitian process, to simulate the ground state of the target quantum system. A real-time unitary evolution related to a Hamiltonian of the system is used for achieving an effect of virtual and real evolution, thus implementing simulation of the ground state of the target quantum system in theory. In addition, this process can be directly implemented by using a quantum circuit, which fully improves operability of the solution.

When the apparatus provided in the foregoing embodiments implements functions of the apparatus, the division of the foregoing functional modules is merely an example for description. In the practical application, the functions may be assigned to and completed by different functional modules according to the requirements, that is, the internal structure of the device is divided into different functional modules, to implement all or some of the functions described above. In addition, the apparatus and method embodiments provided in the foregoing embodiments belong to the same concept. For the specific implementation process, reference may be made to the method embodiments, and details are not described herein again.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

An exemplary embodiment of this disclosure further provides a computer device, the computer device being configured to perform the method for obtaining a ground state of a quantum system. In some examples, the computer device is a quantum computer, or the computer device is a mixed execution environment formed by a quantum computer and a classic computer.

An exemplary embodiment of this disclosure further provides a computer-readable storage medium (such as, a non-transitory computer-readable storage medium), storing at least one instruction, at least one program, a code set or an instruction set, the at least one instruction, the at least one program, the code set or the instruction set being loaded and executed by a processor to perform the method for obtaining a ground state of a quantum system.

In some examples, the computer-readable storage medium may include: a read-only memory (ROM), a random access memory (RAM), solid state drives (SSD), an optical disc, or the like. The RAM may include a resistance random access memory (ReRAM) and a dynamic random access memory (DRAM).

In an exemplary embodiment, a computer program product or a computer program is provided. The computer program product or the computer program includes computer instructions, and the computer instructions are stored in a computer-readable storage medium. A processor of a computer device reads the computer instruction from the computer-readable storage medium, and the processor executes the computer instruction, so that the computer device performs the method for obtaining a ground state of a quantum system.

It is to be understood that “plurality of” mentioned in the specification means two or more. The “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects. In addition, the step numbers described in this specification merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this disclosure.

The foregoing descriptions are merely examples of the embodiments of this disclosure, but are not intended to limit this disclosure. Any modification, equivalent replacement, or improvement made without departing from the spirit and principle of this disclosure shall fall within the scope of this disclosure.

What is claimed is:

1. A method for obtaining a ground state of a quantum system, comprising:
preparing an initial state of the quantum system;
performing an n-step evolution and post-processing operation on the quantum system, wherein n is a first positive integer, the n-step evolution and post-processing operations includes one or more steps that increase a proportion of the ground state in one or more output states of the one or more steps step by step;
obtaining an output quantum state in an n^{th} step in the n-step evolution and post-processing operation; and
determining the ground state of the quantum system based on the output quantum state in the n^{th} step in the n-step evolution and post-processing operation.

2. The method according to claim 1, wherein:
the n-step evolution and post-processing operation comprises n steps in a sequence with an evolution and a post-processing in respective steps, a k^{th} step in the n-step evolution and post-processing operation comprises a k^{th} evolution and a k^{th} post-processing, the k^{th} evolution performs evolution on an input quantum state of the k^{th} Step to obtain a final state of the k^{th} evolution, the k^{th} post-processing removes an influence of an auxiliary qubit used in the k^{th} evolution from the final state of the k^{th} evolution to obtain an output quantum state of the k^{th} step, k is a second positive integer that is less than or equal to n.

3. The method according to claim 2, wherein:
when k is larger than 1, the input quantum state in the k^{th} step comprises a Cartesian product of an output quantum state of a (k−1)^{th} step in the n-step evolution and post-processing operation and an initial state of the auxiliary qubit used in the k^{th} evolution; and
when k is equal to 1, an input quantum state in a first step in the n-step evolution and post-processing operation comprises a Cartesian product of the initial state of the quantum system and an initial state of an auxiliary qubit used in a first evolution of the first step.

4. The method according to claim 3, wherein the performing the n-step evolution and post-processing operation on the quantum system comprises:
performing the k^{th} evolution by using a k^{th} quantum circuit, to obtain the final state of the k^{th} evolution.

5. The method according to claim 3, wherein the performing the n-step evolution and post-processing operation on the quantum system comprises:
performing the k^{th} post-processing by using a k^{th} measuring circuit, and the k^{th} post-processing projecting the auxiliary qubit used in the k^{th} evolution to a 0 state, to obtain the output quantum state of the k^{th} step.

6. The method according to claim 3, wherein an auxiliary qubit is reused in each evolution in the n-step evolution and post-processing operation.

7. The method according to claim 3, wherein at least an m^{th} step in the n-step evolution and post-processing operation comprises an m^{th} variational quantum circuit corresponding to an m^{th} evolution of the m^{th} step, m is a positive integer equal or smaller than n, the method comprises:
performing an m^{th} transformation on a final state of the m^{th} evolution by using the m^{th} variational quantum circuit corresponding to the m^{th} evolution, to obtain a transformed quantum state of the m^{th} step;
adjusting one or more parameters of the m^{th} variational quantum circuit corresponding to the m^{th} evolution to minimize an energy expectation value of the transformed quantum state of the m^{th} step;
obtaining, in response to the one or more parameters of the m^{th} variational quantum circuit corresponding to the m^{th} step of evolution meeting a stop optimization condition, the transformed quantum state after the m^{th} transformation; and
performing an m^{th} post-processing on the transformed quantum state after the m^{th} transformation, to obtain the output quantum state of the m^{th} step.

8. The method according to claim 7, wherein each step in the n-step evolution and post-processing operation is performed by a variational quantum circuit corresponding to an evolution of the step.

9. The method according to claim 8, further comprising:
during the adjusting the one or more parameters of the m^{th} variational quantum circuit corresponding to the m^{th} evolution of the m^{th} step, keeping parameters of other variational quantum circuits of other steps unchanged.

10. The method according to claim 8, further comprising:
adjusting, after the adjusting the one or more parameters of the m^{th} variational quantum circuit corresponding to the m^{th} evolution, parameters of another variational quantum circuit in another step of the n-step evolution and post-processing operation.

11. An apparatus for obtaining a ground state of a quantum system, comprising processing circuitry configured to:
prepare an initial state of the quantum system;
perform an n-step evolution and post-processing operation on the quantum system, wherein n is a first positive integer, the n-step evolution and post-processing operations includes one or more steps that increase a proportion of the ground state in one or more output states of the one or more steps step by step;
obtain an output quantum state in an n^{th} step in the n-step evolution and post-processing operation; and
determine the ground state of the quantum system based on the output quantum state in the n^{th} step in the n-step evolution and post-processing operation.

12. The apparatus according to claim 11, wherein:
the n-step evolution and post-processing operation comprises n steps in a sequence with an evolution and a post-processing in respective steps, a k^{th} step in the n-step evolution and post-processing operation comprises a k^{th} evolution and a k^{th} post-processing, the k^{th} evolution performs evolution on an input quantum state of the k^{th} Step to obtain a final state of the k^{th} evolution, the k^{th} post-processing removes an influence of an auxiliary qubit used in the k^{th} evolution from the final state of the k^{th} evolution to obtain an output quantum state of the k^{th} step, k is a second positive integer that is less than or equal to n.

13. The apparatus according to claim 12, wherein:
when k is larger than 1, the input quantum state in the k^{th} step comprises a Cartesian product of an output quantum state of a (k−1)^{th} step in the n-step evolution and post-processing operation and an initial state of the auxiliary qubit used in the k^{th} evolution; and
when k is equal to 1, an input quantum state in a first step in the n-step evolution and post-processing operation comprises a Cartesian product of the initial state of the quantum system and an initial state of an auxiliary qubit used in a first evolution of the first step.

14. The apparatus according to claim 13, wherein the processing circuitry comprises:
a k^{th} quantum circuit configured to perform the k^{th} evolution to obtain the final state of the k^{th} evolution.

15. The apparatus according to claim 13, wherein the processing circuitry comprises:
a k^{th} measuring circuit configured to perform the k^{th} post-processing, and the k^{th} post-processing projecting the auxiliary qubit used in the k^{th} evolution to a 0 state, to obtain the output quantum state of the k^{th} step.

16. The apparatus according to claim 13, wherein an auxiliary qubit is reused in each evolution in the n-step evolution and post-processing operation.

17. The apparatus according to claim 13, further comprising:
at least an m^{th} variational quantum circuit corresponding to an m^{th} evolution of an m^{th} step in the m^{th} step of the n-step evolution and post-processing operation comprises, m is a positive integer equal or smaller than n, and
the processing circuitry is configured:
perform an m^{th} transformation on the final state of the m^{th} evolution by using the m^{th} variational quantum circuit corresponding to the m^{th} evolution, to obtain a transformed quantum state of the m^{th} step;
adjust one or more parameters of the m^{th} variational quantum circuit corresponding to the m^{th} evolution to minimize an energy expectation value of the transformed quantum state of the m^{th} step;
obtain, in response to the one or more parameters of the m^{th} variational quantum circuit corresponding to the m^{th} step of evolution meeting a stop optimization condition, the transformed quantum state after the m^{th} transformation; and
perform an m^{th} post-processing on the transformed quantum state after the m^{th} transformation, to obtain the output quantum state of the m^{th} step.

18. The apparatus according to claim 17, further comprising, for each step of the n-step evolution and post-processing operation, a variational quantum circuit corresponding to an evolution of the step.

19. The apparatus according to claim 18, wherein the processing circuitry is configured to:
during an adjustment of the one or more parameters of the m^{th} variational quantum circuit corresponding to the m^{th} evolution of the m^{th} step, keeping parameters of other variational quantum circuits of other steps unchanged; and
adjust, after the adjustment of the one or more parameters of the m^{th} variational quantum circuit corresponding to the m^{th} evolution, parameters of another variational quantum circuit in another step of the n-step evolution and post-processing operation.

20. A method for obtaining a ground state of a quantum system, comprising:
using a variational quantum circuit to construct a trial quantum state;
adjusting one or more parameters of the variational quantum circuit to cause the trial quantum state to approach a target quantum state of the quantum system;
setting the trial quantum state constructed by using the variational quantum circuit as a ground state of the quantum system in response to the one or more parameters of the variational quantum circuit meeting a stop optimization condition; and
determining an energy expectation value of a Hamiltonian of the quantum system under the trial quantum state as a ground state energy of the quantum system.
